(19) United States
(12) Patent Application Publication
(10) Pub. No.: US 2016/0229697 A1
(43) Pub. Date: Aug. 11, 2016

(54) Activated Carbon Production at Biomass-Fueled Steam/Electric Power Plants

(71) Applicants: Russel M. Adams, Penryn, CA (US); John W. C. Black, Markham (CA)

(72) Inventors: Russel M. Adams, Penryn, CA (US); John W. C. Black, Markham (CA)

(73) Assignee: Advanced Organic Methods LLC, Penryn, CA (US)

(21) Appl. No.: 15/012,834

(22) Filed: Feb. 1, 2016

Related U.S. Application Data
(60) Provisional application No. 62/112,260, filed on Feb. 5, 2015.

(51) Int. Cl. C01B 31/10

(52) U.S. Cl. CPC C01B 31/10

(57) ABSTRACT

Production of activated carbon at biomass-fueled steam/electric power plants (biomass plants) is described. At a typical biomass plant, various types of woody fuels are combusted to produce steam, and a steam turbine drives a generator to produce electric power. According to the invention, the biomass plant's existing fuel handling, combustion, and ash handling processes are replaced, in whole or in part, by pyrolysis, pyrolysis gas combustion, char activation, and activation offgas combustion using known methods. Carbonaceous feedstocks, typically nut shells which are known to produce high quality activated carbon, are pyrolyzed, producing char containing fixed carbon and ash, while the volatile constituents are driven off and collected. The char is activated by steam to produce activated carbon and syngas. Particulate matter is removed from the volatile pyrolysis products and activation offgas. A fraction of the gases are combusted to sustain the pyrolysis and activation processes and the remainder combusted in the biomass plant's existing combustion chamber to drive the steam/electric power generation process and also produce steam for the activation process. The sale of the activated carbon creates a significant new revenue stream. Application of the invention greatly improves the profitability of the combined operation and reduces air pollution from particulate matter. The reduction of particulate matter emissions, and sequestration of carbon in the activated product, may create additional economic benefits through the sale of air pollution credits and carbon credits respectively.

### BACKGROUND OF THE INVENTION

At a typical steam/electric biomass power plant, various types of woody fuels, typically hogged trees and trimmings, are combusted to produce steam, and a steam turbine drives a generator to produce electric power. Electrical generation capacity of biomass plants (excluding municipal solid waste) in the U.S. totals about 7.5 GWe. Most of these burn hogged forest residue and lumber mill waste. About half of the plants in the U.S. are in the Northeast, and several are in California. They produce renewable-source electric power, and nominal electric generation capacities range from 2.5 MWe to over 200 MWe; although most are in the range of 10 to 25 MWe.

Although some biomass plants have a captured secure fuel source, for example from owned tree farms, many biomass plants are challenged with sourcing enough fuel during economic downturns, for example when lumber production is reduced. Another challenge is the low and variable price paid by many electric utilities for base load renewable-source electric power. Some plants are placed in idle shutdown for years at a time until economic conditions improve. Ash disposal and particulate matter emissions have also posed problems for some biomass plants.

An object of the invention is to retrofit existing biomass plants with activated carbon production facilities, with fuel gas from the pyrolysis and activation processes replacing solid fuel as an energy source for steam generation, thus improving the profitability and environmental profile of the combined operation.

Pyrolysis (destructive distillation) of organic materials consists of heating to approximately 950° F. in the absence of oxygen for a time sufficient to drive off volatile materials (gases, vaporized liquids, and vaporized tars), leaving a char consisting of fixed carbon and ash. Pyrolysis has been practiced in various forms for thousands of years, mostly in batch retorts producing charcoal. Several continuously-operating pyrolysis processes are well known in industry. The term “pyrolysis” as used in this invention is distinct from “torrefaction”, which also operates in the absence of oxygen but at much lower temperatures in the range of 450 to 550° F. The benefit of pyrolysis over torrefaction is the production of a volatile fraction with much lower moisture content and production of char with much higher fixed carbon content and lower residual tars.

In a similar process known as gasification, a controlled amount of air is admitted and partially combusts the feedstock, and a low heating value syngas is produced. A 10-MWe biomass plant in Chowchilla, California utilized two rabble-arm gasifiers in series, producing enough syngas to operate that plant and enough char to fuel a similar size biomass plant nearby. The Chowchilla plant has been dismantled, although gasification is being considered for biomass plants elsewhere due to reduced particulate emissions. The char produced in a gasification plant generally contains too little fixed carbon to be suitable for activation.

Pyrolysis char can be processed by a number of known and commercially proven means into a high-value activated carbon product, typically by contacting with steam at approximately 1300° F., where about half of the fixed carbon is converted into a combustible syngas consisting of carbon monoxide and hydrogen through the well-known water gas reaction. Other means of activation, such as chemical activation, wherein the material is impregnated with activating chemicals such as zinc chloride, phosphoric acid, or potassium hydroxide, then heated in an inert environment and finally washed, are not the subject of this invention.

The ash that otherwise would be produced as a residue of solid fuel combustion is instead retained in the activated carbon product, and so particulate matter emissions from a biomass plant retrofitted according to the invention will be much reduced. Furthermore, much of the fixed carbon in the activated product, and in any biochar produced as a byproduct and used agriculturally, can be considered as sequestered since activated carbon is commonly regenerated, not incinerated, and biochar is stable in the soil environment. Thus, there is potential for reduction of greenhouse gas emissions and also sale of carbon credits.

No biomass plant in the U.S. known to the inventors utilizes pyrolysis and char production, or subsequent activation, as means of generating fuel gas for the steam/electric power generation process as described in the invention.

The market for activated carbon in air and water pollution control, gold ore refining, and numerous industrial and food processing purification processes, is very large. Market report abstracts obtained from internet searches value the annual worldwide market at about $7.5 billion, and growth is projected at 10% per year or more over the next several years. Most activated carbon is produced from coal and some is produced from wood, but many grades preferred in industrial purification applications are produced from coconut shells in China and Southeast Asia. Activated carbon produced from walnut shells and almond shells, reportedly similar in quality to that derived from coconut shells, is available from several manufacturers in mainland China according to an internet search. To the inventors' knowledge, there are no full-scale activated carbon production facilities in the U.S. using nut shell or similar feedstocks.

There are several large scale activated carbon producer/distributors in the U.S., including Calgon Carbon, Mead Westvaco, Cabot, and Carbon Activated, and sale of activated carbon from nut shells and hardwood at adequate prices is not expected to be difficult. A distributor has offered a purchase price of approximately $1,000 per ton for activated carbon from walnut shells equivalent in quality to that made from coconut shells, and pricing for grades certified for potable water treatment and food processing can range up to $2,500 per ton.

Approximately 175,000 tons of walnut shells and 720,000 tons of almond shells were generated in 2013 in California, according to the USDA National Agricultural Statistics Service, most of this in the Sacramento and San Joaquin Valleys. Plantings of these nuts are increasing. Walnut shells are processed and sold wholesale in various size and purity grades for up to $2,000 per ton and more, for a number of different uses such as oil adsorption from petroleum industry wastewaters, grit blasting media, pet bedding, and cosmetic base. Some walnut shells and nearly all of the almond shells are sold un-processed at a much lower price for lower-value uses such as biomass plant fuel and cattle bedding. Approximately 60,000 tons of other nut shells suitable for activated carbon (pistachio, hazelnut, and pecan) were generated in 2013 in Oregon, California, and southern/southwestern states according to USDA data, with evidently little sales potential. Hardwood orchard trimmings and whole trees from orchard removal are a good feedstock for activated carbon. Walnut and almond trees and trimmings are now purchased by biomass plants in the Sacramento and San Joaquin Valleys for about $20 per ton hogged and delivered. Prices paid for orchard wood in California are decreasing, down to zero in some localities, due to the recent and continuing closures of biomass plants because of insufficient revenue from power sales. Smaller amounts of olive pits and pits from stone fruits (peach, plum, cherry, apricot, nectarine, etc.) are purchased by biomass plants and would constitute good activated carbon feedstock as well. Rice hulls and tire crumb are other candidate feedstocks for char and activated carbon production, although the market for the resulting products has not been quantified.

An adequate long-term supply of high and consistent quality feedstock at a reasonable price is key to the successful operation of an activated carbon production plant according to the invention.

### BRIEF DESCRIPTION OF THE DRAWING AND TABLES

FIG. 1 is a diagram of the process according to the invention, and KEY TO FIG. 1 contains the description of the components (letters) and flow streams (numbers). TABLE 1 presents a mass balance and TABLE 2 presents an energy balance for the process depicted in FIG. 1 assuming walnut shell feedstock. TABLES 1 and 2 do not include Streams 20 (High pressure steam), 21 (Stack gas), or 22 (Electric power); these are treated in the detailed description of the invention hereinafter.

### DETAILED DESCRIPTION OF THE INVENTION

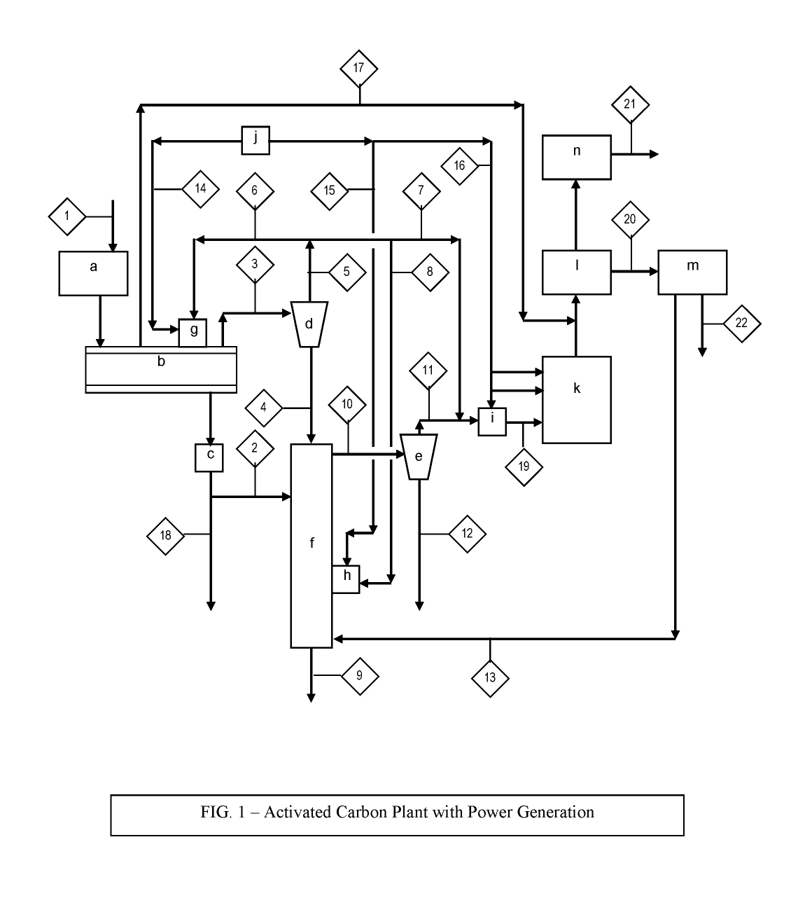

Refer to FIG. 1 and KEY TO FIG. 1. According to the invention, at a biomass plant, the existing combustion chamber (k), boiler (l), turbine generator (m), and stack gas handling equipment (n) are continued in service, while the existing fuel storage and handling equipment (a) is re-purposed as storage and feedstock handling means for a new activated carbon production plant. The existing bottom ash handling equipment is removed.

Feedstock (1), after pre-processing and size reduction as necessary for convenient feeding, at a maximum moisture content of typically 7%, is pyrolysed typically in a continuously operating externally heated rotary kiln or parallel-operating kilns (b) at typically 950° F. using equipment and procedures common in industrial practice. The volatile pyrolysis products driven off in vapor and gaseous form (3) are maintained at a minimum temperature (typically 600° F.) sufficient to prevent condensation throughout subsequent handling and combustion. The char discharged from the pyrolyser undergoes size reduction typically in a roll crusher (c) such that the crushed char is readily fluidized. A small fraction of finely divided char (18), too small for the fluidization process, is collected for further processing and sale in forms such as charcoal briquettes and biochar, or pelletized to a size suitable for fluidization. The remainder (2), along with char fines (4) removed from the pyrolysis products typically by a cyclone (d), is activated in a directly heated vertical single- or multi-stage fluidized bed reactor or parallel-operating reactors (f) operated in continuous or sequential batch mode at typically 1300 to 1350° F. using equipment and procedures common in industrial practice. Low pressure steam (13) at typically 50 psig and 350° F. is drawn from the existing steam turbine and is introduced into the activation reactor(s) and serves as the reactant to activate the carbon. Product carbon (9) is collected, further sized, and packaged for sale. Activated carbon fines (12) are removed from the activation offgas (10) typically in a cyclone (e) and are added to the product carbon or char.

De-dusted pyrolysis volatiles (5) are divided into a fuel gas stream (6) for the pyrolyser burner (g), a fuel gas stream (7) for the boiler burner (i), and a fuel gas stream (8) for the activation reactor burner or burner set (h). De-dusted activation offgas (11) is directed to the boiler burner or, alternatively, used as the means of heating the pyrolyser. Combustion air (14), (15), (16) for burners (g), (h), (i), and combustion chamber overfire air, is provided by an atmospheric air forced draft blower (j). A small amount of high-temperature flue gas from the pyrolyser burner (17) at typically 950° F. is added to the hot combustion chamber offgas powering the existing boiler (i). High-pressure steam (20), at typically 650 psig and 750° F., drives the turbine generator producing electricity (22) sold to the power utility.

Since all fuel gas is de-dusted and the ash content in the feedstock is carried offsite as a component of the carbon products, the existing bottom ash handling equipment in the combustion chamber (k) can be removed. The biomass plant's stack gas handling equipment, including flue gas recirculation and selective catalytic reduction process for control of nitrogen oxides and heat recovery, heat recovery steam generator, particulate removal equipment (baghouse, electrostatic precipitator, etc.), and sulfur oxides control process, as they exist at specific plants, remain in service. Since according to the invention the particulates in the fuel gas have been nearly eliminated prior to combustion, particulate matter emissions in the stack gas (21) are expected to be reduced by over 85% compared with emissions from the original biomass plant. For biomass plants where emissions of sulfur oxides are limited by permit, common practice is to feed crushed limestone into the combustion chamber where it is calcined, the calcium reacting with the sulfur oxides to form calcium sulfate (gypsum), and the gypsum disposed of as a component of flyash. Application of the invention will render the produced gypsum recoverable for sale as byproduct agricultural gypsom since there will be very little flyash.

Projected economic and environmental benefits resulting from application of the invention are presented for a specific example in the preferred embodiment.

### Preferred Embodiment

Refer to FIG. 1, KEY TO FIG. 1, and TABLES 1 and 2. In the preferred embodiment of the invention, an example biomass plant with a nominal power production rating of 10 MWe is retrofitted with activated carbon production and associated fuel gas generation facilities using walnut shells as an example feedstock. Walnut shells at 7% moisture (1) are fed at a constant rate of 10 dry tons per hour into the externally heated rotary kiln pyrolyser (b), producing char and raw gas. Char exiting the roll crusher (c) contains about 5% fines by weight (18), or 341 lb/hr, for further processing without activation. The activation burner set (h), typically one burner per stage in a multiple-stage fluidized bed activation reactor (f), is operated at stoichiometric or slightly sub-stoichiometric oxygen ratio so as to avoid combusting the char, and provides the heat and most of the fluidization energy. Steam is injected at a rate considerably in excess of stoichiometric ratio. Based on literature values and preliminary testing, it is assumed that about 50% of the char is lost through reaction with the process steam (13). Combined with the small amount of activated carbon fines from the activation offgas cyclone, the overall weight yield of saleable activated carbon from dry feedstock, (9) plus (12), is expected to be about 17%.

A typical biomass plant generates nominally 1 MW of electric power for each wet ton per hour of variable moisture content biomass fuel combusted. If a 10-MWe biomass plant is retrofitted with activated carbon production facilities according to the invention, processing 10 dry tons per hour of walnut shells, it is estimated that about 5.6 MWe can be generated, or just over half of the original plant's nominal electric power production rate, while producing 1.7 tons per hour of activated carbon at an assumed $1,000 per ton sale price. Base load renewable-source power is currently purchased by investor-owned utilities in California for between $32 and $50 per MWh. The assumption made for this example is that the average price paid is $40 per MWh. Furthermore, it is assumed that fuel for the biomass plant can be obtained for $20 per wet ton, but that unprocessed walnut shells for activated carbon will cost $60 per dry ton in order to secure a long-term supply. For this example, assuming an 8,000-hr. operating year, the quantity of walnut shells needed (wet basis) is 86,000 tons per year, amounting to about half of what is currently produced in California.

Using the above assumptions, assuming an 8,000-hr. operating year, estimates of annual gross margin (revenue from sales of power and activated carbon less cost of feedstock) for the existing 10-MWe biomass plant compared with the same plant retrofitted according to the invention, are presented in the following table. The small revenues from sale of ash from the existing plant, and of char and gypsum from the retrofitted plant, are not included.

| | | Activated | | |
|---|---|---|---|---|
| | Power | carbon | Cost of | Gross |
| | revenue | revenue | feedstock | margin |
| Existing | $3.2 MM/y | nil | <$1.6 MM/y> | $1.6 MM/y |
| biomass | | | | |
| plant | | | | |
| Retrofitted | $2.2 MM/y | $13.6 MM/y | <$4.8 MM/y> | $10.6 MM/y |
| plant | | | | |

With respect to particulate matter (PM) emissions, an operating permit for an existing 22-MWe biomass plant in northern California was reviewed. This permit limits the combined PM10 and PM2.5 emissions to 30.73 lb/hr. In the case of the example 10-MWe plant in the preferred embodiment, this translates to a permitted 14 lb/hr. As retrofitted according to the invention, the total PM in the flue gas is only 1.8 lb/hr as shown in TABLE 2, Stream 19, entries for “Ash (lb/hr)”, constituting an 87% reduction relative to permit limits even without operating any emissions control equipment. For an 8,000-hr. operating year, this translates to a reduction of nearly 49 tons per year. Pollution credits for PM reduction are sold in California for up to $50,000 per ton/y; therefore, the pollution credits according to the preferred embodiment of the invention could potentially be worth as much as $2.4 million.

Major equipment necessary to retrofit a 10-MWe biomass plant according to the preferred embodiment would include four parallel identical pyrolyser/activation reactor lines, due to size limitations of available equipment and to allow for operational flexibility, with one line dedicated as an installed spare to allow for breakdowns and major equipment cleanouts during the operating season. The pyrolysers would be approximately 12 ft. dia. and 60 ft. long, and the activation reactors would be approximately 10 ft. dia. and 40 ft. tall. The activated carbon plant would be located adjacent to the existing combustion chamber, and occupy a footprint approximately 100 ft. square (¼ acre), approximately 5% of the total area of a typical 10-MWe biomass plant.

The scope of the preferred embodiment includes installations scaled appropriate to biomass plants of various sizes, including activation plant capacity sufficient to utilize all of the biomass plant's rated electric power production capacity. In the case of the example for walnut shells in the preferred embodiment, 17.7 dry tons per hour of shells would have to be processed in order to utilize all of the 10-MWe rated capacity.

The scope of the preferred embodiment also includes utilization of other feedstocks suitable for production of high quality activated carbon, including but not limited to dried spent walnut shell media from oil adsorption; pure and mixed streams of other nut shells such as hazelnut, pecan, almond, pistachio, brazil nut, macadamia, and coconut; pure and mixed streams of stone fruit and olive pits; dried hardwood and softwood; rice hulls; tire crumb; lignite; and coal.

### Alternative Embodiments

Although from a business perspective it is advantageous to utilize a biomass plant's existing facilities and active permits when retrofitting according to the invention, the same effect can be achieved by constructing a new purpose-built plant as an alternative embodiment of the invention.

In the numerous cases where two identical boiler/generator trains exist at a biomass plant, an alternative embodiment of the invention is to retrofit one of these according to the invention, with the other remaining in service combusting solid biomass fuel or idled for future retrofitting.

Municipal solid waste incineration plants combust some cellulosic residues and generate electricity using steam turbines, and they are treated in this invention as an alternative embodiment having a potential for partial retrofitting to produce activated carbon from a new source of suitable feedstock.

An alternative embodiment of the invention is to introduce spent activated carbon either alone or along with char into the activation reactor for re-activation and sale as a component of product carbon.

An alternative embodiment of the invention is to utilize natural gas as a supplemental fuel in the biomass plant's combustion chamber, augmenting the fuel gas derived from the pyrolysis and activation processes.

An alternative embodiment of the invention is to feed solid biomass fuel into the biomass plant's combustion chamber to augment the fuel gas derived from the pyrolysis and activation processes. In this embodiment, the bottom ash handling equipment would be retained.

An alternative embodiment of the invention is to omit the activation reactor and produce only biochar for sale.

The scope of the invention includes application of all known and commercially proven methods for continuous pyrolysis and steam char activation other than those specified herein, including but not limited to vertical rabble-arm pyrolysers, inert gas internally heated rotary kilns, fluidized bed pyrolysers or low temperature gasifiers, externally heated rotary kiln activation / reactivation reactors, sequential batch operation of activation reactors where multiple processing lines are installed, and the Continuous Ablative Reactor according to U.S. Pat. No. 5,770,017.

The scope of the invention includes processing of feedstock prior to pyrolysis by means such as drying, de-stoning, and size reduction; and removal of less desirable feedstock constituents, for example removal of almonds, hulls, and the soft outer shell layer from as-received almond shell feedstock.

From the general principles and detailed description of the invention presented herein, those skilled in the art will readily comprehend the various modifications to which the invention is susceptible. Therefore, the inventors desire to be limited only by the scope of the following claims and legal equivalents thereof.

### KEY TO FIG. 1

### Components

a. Feedstock storage and feeding means (part existing)

b. Continuously operating pyrolysis means

c. Size reduction and sizing means

d. Pyrolyser cyclonic gas/solid separation means

e. Char activator cyclonic gas/solid separation means

f. Continuously operating char activation means

g. Pyrolyser gaseous fuel burner

h. Char activator gaseous fuel burner or burner set

i. Boiler gaseous fuel burner

j. Atmospheric air forced draft blower

k. Existing biomass plant combustion chamber

l. Existing biomass plant boiler

m. Existing biomass plant steam turbine generator and condenser

n. Existing biomass plant stack gas treatment equipment

### Flow Streams

1. Walnut shells (example for TABLES 1 and 2)

2. Crushed char

3. Raw pyrolysis gas

4. Pyrolyser cyclone solids

5. De-dusted pyrolysis gas

6. Pyrolysis burner gas

7. Boiler fuel gas

8. Activator burner gas

9. Product carbon

10. Activation offgas

11. Dedusted activation gas

12. Activator cyclone solids

13. Process steam

14. Pyrolyser burner air

15. Activator burner air

16. Boiler burner air

17. Pyrolyser flue gas

18. Char fines

19. Combustion gas

20. High pressure steam

21. Stack gas to atmosphere

22. Electric power

TABLE 1
Mass Balance for FIG. 1

| | Stream Number | | | | | | | |
|---|---|---|---|---|---|---|---|---|
| | 1 | 2 | 3 | 4 | 5 | 6 | 7 | 8 |
| | Stream Name | | | | | | | |
| | Walnut | Crushed | | Cyclone | Dedusted | Pyrolysis | Boiler | Activator |
| | Shells | Char | Raw Gas | Solids | Gas | Burner Gas | Fuel Gas | Burner Gas |
| Temperature, ° F. | 70 | 150 | 950 | 950 | 950 | 950 | 950 | 950 |
| Pressure, psia | — | — | — | — | — | — | — | — |
| Total Gas Flowrate (lb/hr) | — | — | 14,540 | — | 14,540 | 775 | 6,386 | 7,390 |
| Total Flowrate, scfh | — | — | 196,341 | — | 196,341 | 10,463 | 86,468 | 99,787 |
| Total Flowrate, scfm | — | — | 3,272 | — | 3,272 | 174 | 1,441 | 1,663 |
| C, (lb/hr) | 10,102.7 | 5,462.9 | 4,352.3 | 97.7 | 4,254.6 | 226.7 | 1,865.5 | 2,162.3 |
| H, (lb/hr) | 1,426.1 | 317.8 | 1,091.6 | 5.7 | 1,085.9 | 57.9 | 476.1 | 551.9 |
| O, (lb/hr) | 9,611.4 | 434.5 | 9,154.0 | 7.8 | 9,146.2 | 487.4 | 4,010.4 | 4,648.4 |
| N, (lb/hr) | 92.8 | 25.8 | 65.6 | 0.5 | 65.2 | 3.5 | 28.6 | 33.1 |
| S, (lb/hr) | 15.8 | 4.4 | 11.2 | 0.1 | 11.1 | 0.6 | 4.9 | 5.6 |
| Ash (lb/hr) | 256.7 | 239.0 | 5.1 | 4.3 | 0.9 | 0.05 | 0.4 | 0.4 |
| Total | 21,505 | 6,484 | 14,680 | 116 | 14,564 | 776 | 6,386 | 7,401.844 |
| Feedstock Moisture (%) | 7 | | | | | | | |
| Solids Feed Rate | | | | | | | | |
| Dry Feed (lb/hr) | 20,000 | | | | | | | |
| Water in Feed (lb/hr) | 1,505 | | | | | | | |
| Component Flow Rates | | | | | | | | |
| CO (lb/hr) | — | — | 1,758.7 | — | 1,758.7 | 93.7 | 771.2 | 893.8 |
| CO2 (lb/hr) | — | — | 3,326.0 | — | 3,326.0 | 177.2 | 1,458.4 | 1,690.4 |
| H2 (lb/hr) | — | — | 55.6 | — | 55.6 | 3.0 | 24.4 | 28.3 |
| CH4 (lb/hr) | — | — | 352.6 | — | 352.6 | 18.8 | 154.6 | 179.2 |
| C2H2 (lb/hr) | — | — | 0.6 | — | 0.6 | 0.0 | 0.3 | 0.3 |
| C2H4 (lb/hr) | — | — | 6.2 | — | 6.2 | 0.3 | 2.7 | 3.1 |
| C2H6 (lb/hr) | — | — | 283.2 | — | 283.2 | 15.1 | 124.2 | 143.9 |
| C3 (lb/hr) | — | — | 9.7 | — | 9.7 | 0.5 | 4.2 | 4.9 |
| C4 (lb/hr) | — | — | 1.3 | — | 1.3 | 0.1 | 0.6 | 0.6 |
| C5 (lb/hr) | — | — | 1.5 | — | 1.5 | 0.1 | 0.7 | 0.8 |
| H2O (lb/hr) | — | — | 5,717.4 | — | 5,717.4 | 304.7 | 2,506.9 | 2,905.8 |
| H2S (lb/hr) | — | — | 6.9 | — | 6.9 | 0.4 | 3.0 | 3.5 |
| NH3 (lb/hr) | — | — | 33.8 | — | 33.8 | 1.8 | 14.8 | 17.2 |
| N2 (lb/hr) | — | — | 0.0 | — | 0.0 | 0.0 | 0.0 | 0.0 |
| SO2 (lb/hr) | — | — | | — | — | — | — | — |
| NOx (lb/hr) | — | — | | — | — | — | — | — |
| O2 (lb/hr) | — | — | | — | — | — | — | — |
| Total Gas (lb) | — | — | 11,553 | — | 11,553 | 616 | 5,066 | 5,872 |
| Number of lb moles | — | — | 517 | — | 517 | 28 | 228 | 263 |
| Average Molecular weight | — | — | 22.33 | — | 22.33 | 22.33 | 22.23 | 22.33 |
| Condensible Liquids (lb/hr) | — | — | 2,987.05 | — | 2,987.05 | 159.18 | 1,309.74 | 1,518.13 |
| Ash (lb/hr) | — | — | — | — | — | — | — | — |
| Char (lb/hr) | — | 6,484.34 | 139.30 | 115.96 | 23.34 | 1.24 | 10.23 | 11.86 |
| Steam (lb/hr) | — | — | — | — | — | — | — | — |
| Feedstock (lb/hr) | 21,505 | — | — | — | — | — | — | — |
| Total (lb/hr) | 21,505 | 6,484 | 14,680 | 116 | 14,564 | 776 | 6,386 | 7,402 |

| | Stream Number | | | | | |
|---|---|---|---|---|---|---|
| | 9 | 10 | 11 | 12 | 13 | 14 |
| | Stream Name | | | | | |
| | | | Dedusted | | | |
| | Product | Activation | Activation | Act. Cycl. | Process | Pyrolyser |
| | Carbon | Off-Gas | Gas | Solids | Steam | Burner Air |
| Temperature, ° F. | 1350 | 1350 | 1350 | 1350 | 350 | 100 |
| Pressure, psia | — | — | — | — | 50 | — |
| Total Gas Flowrate (lb/hr) | — | 41,239 | 41,239 | — | 6,600 | 2,900 |
| Total Flowrate, scfh | — | 692,801 | 692,801 | — | 139,031 | 38,369 |
| Total Flowrate, scfm | — | 11,547 | 11,547 | — | 2,317 | 639 |
| C, (lb/hr) | 2,953.7 | 4,769.2 | 4,721.2 | 48.0 | — | — |
| H, (lb/hr) | 67.2 | 1,572.1 | 1,571.0 | 1.1 | 738.6 | 3.1 |
| O, (lb/hr) | 79.0 | 16,610.3 | 16,609.0 | 1.3 | 5,861.7 | 691.8 |
| N, (lb/hr) | 7.7 | 18,342.6 | 18,342.5 | 0.1 | — | 2,205.6 |
| S, (lb/hr) | 1.8 | 8.4 | 8.3 | 0.0 | — | — |
| Ash (lb/hr) | 238.4 | 5.3 | 1.4 | 3.9 | — | — |
| Total | 3,348 | 41,307.830 | 41,253 | 54 | 6,600 | 2,900 |
| Feedstock Moisture (%) | | | | | | |
| Solids Feed Rate | | | | | | |
| Dry Feed (lb/hr) | | | | | | |
| Water in Feed (lb/hr) | | | | | | |
| Component Flow Rates | | | | | | |
| CO (lb/hr) | — | 4,922.0 | 4,922.0 | — | — | — |
| CO2 (lb/hr) | — | 9,512.5 | 9,512.5 | — | — | — |
| H2 (lb/hr) | — | 704.3 | 704.3 | — | — | — |
| CH4 (lb/hr) | — | 2.8 | 2.8 | — | — | — |
| C2H2 (lb/hr) | — | 0.0 | 0.0 | — | — | — |
| C2H4 (lb/hr) | — | 0.0 | 0.0 | — | — | — |
| C2H6 (lb/hr) | — | 0.0 | 0.0 | — | — | — |
| C3 (lb/hr) | — | 0.0 | 0.0 | — | — | — |
| C4 (lb/hr) | — | 0.0 | 0.0 | — | — | — |
| C5 (lb/hr) | — | 0.0 | 0.0 | — | — | — |
| H2O (lb/hr) | — | 7,698.9 | 7,698.9 | — | — | 27.3 |
| H2S (lb/hr) | — | 2.9 | 2.9 | — | — | — |
| NH3 (lb/hr) | — | 22.3 | 22.3 | — | — | — |
| N2 (lb/hr) | — | 18,291.0 | 18,291.0 | — | — | 2,205.6 |
| SO2 (lb/hr) | — | 11.2 | 11.2 | — | — | — |
| NOx (lb/hr) | — | 71.0 | 71.0 | — | — | — |
| O2 (lb/hr) | — | — | — | — | — | 667.5 |
| Total Gas (lb) | — | 41,239 | 41,239 | — | — | 2,900 |
| Number of lb moles | — | 1,826 | 1,826 | — | 366 | 101 |
| Average Molecular weight | — | 22.59 | 22.59 | — | — | 28.69 |
| Condensible Liquids (lb/hr) | — | 0.06 | 0.06 | — | — | — |
| Ash (lb/hr) | — | 0.44 | 0.44 | — | — | — |
| Char (lb/hr) | 3,347.74 | 68.32 | 13.91 | 54.42 | — | — |
| Steam (lb/hr) | — | — | — | — | 6,600 | — |
| Feedstock (lb/hr) | — | — | — | — | — | — |
| Total (lb/hr) | 3,348 | 41,308 | 41,253 | 54 | 6,600 | 2,900 |

| | Stream Number | | | | |
|---|---|---|---|---|---|
| | 15 | 16 | 17 | 18 | 19 |
| | Stream Name | | | | |
| | Activator | Boiler | Pyrolyser | Charcoal | Combustion |
| | Burner Air | Burner Air | Flue Gas | Fines | Gas |
| Temperature, ° F. | 100 | 100 | 950 | 150 | 2884 |
| Pressure, psia | — | — | — | — | — |
| Total Gas Flowrate (lb/hr) | 839 | 66,356 | 3,676 | — | 113,996 |
| Total Flowrate, scfh | 161,718 | 877,819 | 931,545 | — | 1,563,886.52 |
| Total Flowrate, scfm | 5,303 | 14,630 | 15,526 | — | 26,065 |
| C, (lb/hr) | — | — | 226.7 | 287.5 | 6,586.7 |
| H, (lb/hr) | 25.3 | 69.9 | 60.9 | 16.7 | 2,117.0 |
| O, (lb/hr) | 5,736.8 | 15,826.5 | 1,179.2 | 22.9 | 36,445.8 |
| N, (lb/hr) | 18,291.0 | 50,460.1 | 2,209.1 | 1.4 | 68,831.2 |
| S, (lb/hr) | — | — | 0.6 | 0.2 | 13.2 |
| Ash (lb/hr) | — | — | 0.05 | 12.6 | 1.8 |
| Total | 24,053 | 66,356 | 3,677 | 341 | 113,996 |
| Feedstock Moisture (%) | | | | | |
| Solids Feed Rate | | | | | |
| Dry Feed (lb/hr) | | | | | |
| Water in Feed (lb/hr) | | | | | |
| Component Flow Rates | | | | | |
| CO (lb/hr) | — | — | — | — | |
| CO2 (lb/hr) | — | — | 830.8 | — | 24,134.3 |
| H2 (lb/hr) | — | — | — | — | |
| CH4 (lb/hr) | — | — | — | — | |
| C2H2 (lb/hr) | — | — | — | — | |
| C2H4 (lb/hr) | — | — | — | — | |
| C2H6 (lb/hr) | — | — | — | — | |
| C3 (lb/hr) | — | — | — | — | |
| C4 (lb/hr) | — | — | — | — | |
| C5 (lb/hr) | — | — | — | — | |
| H2O (lb/hr) | 226.4 | 624.5 | 544.4 | — | 18,918.6 |
| H2S (lb/hr) | — | — | — | — | |
| NH3 (lb/hr) | — | — | — | — | |
| N2 (lb/hr) | 18,291.0 | 50,460.1 | 2,205.6 | — | 68,751.1 |
| SO2 (lb/hr) | — | — | 1.2 | — | 26.3 |
| NOx (lb/hr) | — | — | 7.4 | — | 171.6 |
| O2 (lb/hr) | 5,535.8 | 15,271.9 | 87.1 | — | 1,992.0 |
| Total Gas (lb) | 24,053 | 66,356 | 3,676 | — | 113,993.9 |
| Number of lb moles | 839 | 2,313 | 130.82 | — | 4,121.1 |
| Average Molecular weight | 28.69 | 28.69 | 28.10 | — | 27.7 |
| Condensible Liquids (lb/hr) | — | — | — | — | — |
| Ash (lb/hr) | — | — | 0.05 | — | 1.80 |
| Char (lb/hr) | — | — | — | 341.28 | — |
| Steam (lb/hr) | — | — | — | — | — |
| Feedstock (lb/hr) | — | — | — | — | — |
| Total (lb/hr) | 24,053 | 66,356 | 3,677 | 341 | 113,996 |

TABLE 2
Energy Balance for FIG. 1

| | Stream Number | | | | | | | |
|---|---|---|---|---|---|---|---|---|
| | 1 | 2 | 3 | 4 | 5 | 6 | 7 | 8 |
| | Stream Name | | | | | | | |
| | Walnut | Crushed | | Cyclone | Dedusted | Pyrolysis | Boiler | Activator |
| | Shells | Char | Raw Gas | Solids | Gas | Burner Gas | Fuel Gas | Burner Gas |
| Temperature, ° F. | 70 | 150 | 950 | 950 | 950 | 950 | 950 | 950 |
| Pressure, psig | | — | — | — | — | — | — | — |
| Heat In | Btu/hr | Btu/hr | Btu/hr | Btu/hr | Btu/hr | Btu/hr | Btu/hr | Btu/hr |
| HHV of Fuel | 174,330,089 | | | | | | | |
| Sens. Heat in Fuel | −40,668 | | | | | | | |
| Latent + Sens. Heat in Fuel | −10,509 | | | | | | | |
| Moisture | | | | | | | | |
| Latent Heat In Inlet Air | | | | | | | | |
| Sensible Heat in Inlet Air | | | | | | | | |
| Heat added | 2,505,427 | | | | | | | |
| Sensible Heat of Product Gas | | | 4,060,860 | | 4,060,860 | 216,408 | 1,780,578 | 2,063,874 |
| Sensible + Latent Heat of | | | 1,253,542 | | 1,253,542 | 66,803 | 549,644 | 637,095 |
| Product Tar | | | | | | | | |
| Sensible Heat of Char | | 142,007 | 36,482 | 30,370 | 6,113 | 326 | 2,680 | 3,107 |
| Sensible Heat of Ash | | | 0 | 0 | 0 | 0 | 0 | 0 |
| Sensible Heat of Activated Carbon | | | | | | | | |
| Sensible Heat of Water | | | | | | | | |
| Latent Heat of Water | | | 6,009,224 | | 6,009,224 | 320,239 | 2,634,883 | 3,054,103 |
| Heat of Adsorption of Water | | | 465,269 | | | | | |
| HHV of Gas | | | 26,539,098 | | 26,539,098 | 1,414,300 | 11,636,679 | 13,488,118 |
| HHV of Tar | | | 37,264,623 | | 37,264,623 | 1,985,876 | 16,339,533 | 18,939,214 |
| HHV of Char | | 89,265,219 | 1,917,620 | 1,596,328 | 321,293 | 17,122 | 140,878 | 163,292 |
| Heat loss | | 1,556,241 | 3,486,602 | | | | | |
| Total | 176,784,338 | 90,963,467 | 81,033,321 | 1,626,697 | 75,454,752 | 4,021,074 | 33,084,876 | 38,348,803 |

| | Stream Number | | | | | |
|---|---|---|---|---|---|---|
| | 9 | 10 | 11 | 12 | 13 | 14 |
| | Stream Name | | | | | |
| | | | Dedusted | | | |
| | Product | Activation | Activation | Act. Cycl. | Process | Pyrolyser |
| | Carbon | Off-Gas | Gas | Solids | Steam | Burner Air |
| Temperature, ° F. | 1350 | 1350 | 1350 | 1350 | 350 | 100 |
| Pressure, psig | | | — | | 50 | |
| Heat In | Btu/hr | Btu/hr | Btu/hr | Btu/hr | Btu/hr | Btu/hr |
| HHV of Fuel | | | | | | |
| Sens. Heat in Fuel | | | | | | |
| Latent + Sens. Heat in Fuel | | | | | | |
| Moisture | | | | | | |
| Latent Heat In Inlet Air | | | | | | 28,688 |
| Sensible Heat in Inlet Air | | | | | | 16,114 |
| Heat added | | | | | | |
| Sensible Heat of Product Gas | | 18,869,183 | 18,869,183 | | | |
| Sensible + Latent Heat of | | 34 | 34 | | | |
| Product Tar | | | | | | |
| Sensible Heat of Char | 1,278,502 | 26,092 | 5,311 | 20,781 | | |
| Sensible Heat of Ash | 0 | 139 | 139 | 0 | | |
| Sensible Heat of Activated Carbon | | | | | | |
| Sensible Heat of Water | | | | | 2,736,438 | |
| Latent Heat of Water | | 8,091,953 | 8,091,953 | | 6,937,232 | |
| Heat of Adsorption of Water | | | | | | |
| HHV of Gas | | 64,650,995 | 64,650,995 | | | |
| HHV of Tar | | 800 | 800 | | | |
| HHV of Char | 44,060,775 | 899,199 | 183,020 | 716,179 | | |
| Heat loss | | 1,550,269 | | | | |
| Total | 45,339,277 | 94,088,666 | 91,801,437 | 736,960 | 9,673,670 | 44,802 |

| | Stream Number | | | | |
|---|---|---|---|---|---|
| | 15 | 16 | 17 | 18 | 19 |
| | Stream Name | | | | |
| | Activator | Boiler | Pyrolyser | Charcoal | Combustion |
| | Burner Air | Burner Air | Flue Gas | Fines | Gas |
| Temperature, ° F. | 100 | 100 | 950 | 150 | 2884 |
| Pressure, psig | | | | | |
| Heat In | Btu/hr | Btu/hr | Btu/hr | Btu/hr | Btu/hr |
| HHV of Fuel | | | | | |
| Sens. Heat in Fuel | | | | | |
| Latent + Sens. Heat in Fuel | | | | | |
| Moisture | | | | | |
| Latent Heat In Inlet Air | 237,910 | 656,332 | | | |
| Sensible Heat in Inlet Air | 133,637 | 368,672 | | | |
| Heat added | | | | | |
| Sensible Heat of Product Gas | | | 3,421,276 | | 104,668,360 |
| Sensible + Latent Heat of | | | | | |
| Product Tar | | | | | |
| Sensible Heat of Char | | | | 7,474 | |
| Sensible Heat of Ash | | | 33 | | 1,266 |
| Sensible Heat of Activated Carbon | | | | | |
| Sensible Heat of Water | | | 572,236 | | |
| Latent Heat of Water | | | | | 19,884,398 |
| Heat of Adsorption of Water | | | | | |
| HHV of Gas | | | | | |
| HHV of Tar | | | | | |
| HHV of Char | | | | 4,698,169 | |
| Heat loss | | | 72,332 | 81,907 | 1,357,292 |
| Total | 371,547 | 1,025,004 | 4,065,877 | 4,787,551 | 125,911,316 |

We claim:

1. The practice of producing activated carbon from carbonaceous feedstocks at the site of an existing steam/electric biomass power plant, comprising the sequential steps of:
a. Pyrolysis of said carbonaceous feedstocks to a char with high fixed carbon content utilizing any of various known and commercially proven means; and
b. Steam activation of said char utilizing any of various known and commercially proven means.

2. The practice of claim 1 wherein combustible constituents driven off during said pyrolysis and steam activation are utilized as a fuel source for the existing steam generation means at said existing steam/electric biomass power plant.

3. The practice of claim 1 wherein the steam for said steam activation is drawn from the existing steam generation means at said existing steam/electric biomass power plant.

4. The practice of claim 1 wherein said carbonaceous feedstocks consist of nut shells including but not limited to walnut, almond, pecan, hazelnut, and pistachio.

5. The practice of claim 1 wherein said carbonaceous feedstocks consist of hardwood derived from orchard removal and trimming and from woodland maintenance including but not limited to walnut, almond, hazelnut, peach, plum, apricot, cherry, and oak.

6. The practice of claim 1 wherein said carbonaceous feedstocks consist of olive pits, and of stone fruit pits including but not limited to peach, plum, apricot, nectarine, and cherry.

7. The practice of claim 1 wherein said carbonaceous feedstocks consist of softwood including but not limited to pine, hemlock, fir, eucalyptus, cottonwood, and larch.

8. The practice of claim 1 wherein said carbonaceous feedstocks consist of rice hulls and tire crumb.

9. The practice of claim 1 wherein said carbonaceous feedstocks consist of any combination of carbonaceous feedstocks described in claims 4 through 8 inclusive.

10. The practice of producing char with high fixed carbon content from carbonaceous feedstocks at the site of an existing steam/electric biomass power plant utilizing any of various known and commercially proven pyrolysis means.

11. The practice of claim 10 wherein combustible constituents driven off during said pyrolysis means are utilized as a fuel source for the existing steam generation means at said existing steam/electric biomass power plant.

12. The practice of claim 10 wherein said carbonaceous feedstocks consist of nut shells including but not limited to walnut, almond, pecan, hazelnut, and pistachio.

13. The practice of claim 10 wherein said carbonaceous feedstocks consist of hardwood derived from orchard removal and trimming and from woodland maintenance including but not limited to walnut, almond, hazelnut, peach, plum, apricot, cherry, and oak.

14. The practice of claim 10 wherein said carbonaceous feedstocks consist of olive pits, and of stone fruit pits including but not limited to peach, plum, apricot, nectarine, and cherry.

15. The practice of claim 10 wherein said carbonaceous feedstocks consist of softwood including but not limited to pine, hemlock, fir, eucalyptus, cottonwood, and larch.

16. The practice of claim 10 wherein said carbonaceous feedstocks consist of rice hulls and tire crumb.

17. The practice of claim 10 wherein said carbonaceous feedstocks consist of any combination of carbonaceous feedstocks described in claims 12 through 16 inclusive.
